(19) United States
(12) Patent Application Publication
(10) Pub. No.: US 2013/0074305 A1
(43) Pub. Date: Mar. 28, 2013

(54) SHOT PEENING/BLASTING PROCESS FOR PART FLATNESS

(71) Applicant: Cesare A. TOLENTINO, Flagstaff, AZ (US)

(72) Inventor: Cesare A. TOLENTINO, Flagstaff, AZ (US)

(73) Assignee: Apple Inc., Cupertino, CA (US)

(21) Appl. No.: 13/243,378

(22) Filed: Sep. 23, 2011

(51) Int. Cl. G01B 21/32; B24C 1/10

(52) U.S. Cl. 29/407.05; 29/705

(57) ABSTRACT

Accurate and reliable techniques for providing a shot peening process kit used for mass production of thin walled aluminum components.

### FIELD OF THE DESCRIBED EMBODIMENTS

The described embodiments generally relate to portable electronic devices. More particularly, the present embodiments describe use of multiple sensors in combination to confirm a status of an accessory device in relation to an electronic device.

### DESCRIPTION OF THE RELATED ART

Shot peening is a cold working process used to produce a residual compressive stress layer and modify mechanical properties of metals. It entails impacting a surface with shot (round metallic, glass, or ceramic particles) with force sufficient to create plastic deformation. In this way, each particle functions as a ball-peen hammer In addition to improving the mechanical properties of the metal, shot peening can act as a finishing process that provides an aesthetically pleasing cosmetic finish. For example, aluminum has been well established for use in consumer electronic products. More particularly, the use of aluminum in housings for portable computing device such as laptops has become fairly common In order to provide a desired finish, the aluminum housing can undergo a shot peening finish process.

However, the shot peening process results in localized plastic deformation in addition to the residual compressive stress layer. Although the residual compressive surface stresses enhance fatigue and corrosion resistance, the compressive stresses can also introduce undesirable part distortion. These compressive based distortions are most problematic for components with thin-walled geometries where the tolerance bands for the components are narrow. These distortions can be especially problematic for thin walled structures, such as a laptop computer housing, that is used to enclose and support operational components such as a display. For example, a distortion in the form of bowing on the order of less than 0.5 mm can make it difficult to align and mount operational components within the computer housing thereby greatly affecting assembly throughput and overall yields.

Accordingly, it would be desirable to develop a method that predicts and compensates for peening-induced distortion of thin walled objects with generalized geometries.

### SUMMARY OF THE DESCRIBED EMBODIMENTS

This paper describes various embodiments that relate to a system for providing a shot peening test kit used in a mass production environment in the production of thin walled aluminum components. The thin walled aluminum components are used to fabricate aesthetically pleasing consumer electronic products such as a laptop computer, tablet computer, and the like.

In one embodiment, a method for creating a shot peening process test kit is described. The method is carried out by performing at least the following operations: (a) determining a time dependent variation of a shot peening machine, (b) determining a machine to machine variation between a plurality of shot peening machines, (c) measuring an arc height of a component under test subsequent to a shot peening process, (d) correlating the measured arc height to a measured arc height of an aluminum Almen test strip exposed to the shot peening process, and (e) creating a shot peening test kit in accordance with (a)-(d).

In another embodiment, an apparatus for creating a shot peening process test kit is disclosed. The apparatus includes at least means for determining a time dependent variation of a shot peening machine, means for determining a machine to machine variation between a plurality of shot peening machines, means for measuring an arc height of a component under test subsequent to a shot peening process, means for correlating the measured arc height to a measured arc height of an aluminum Almen test strip exposed to the shot peening process, and means for creating a shot peening test kit.

Other aspects and advantages of the invention will become apparent from the following detailed description taken in conjunction with the accompanying drawings which illustrate, by way of example, the principles of the described embodiments.

### BRIEF DESCRIPTION OF THE DRAWINGS

The invention will be readily understood by the following detailed description in conjunction with the accompanying drawings, wherein like reference numerals designate like structural elements, and in which:

FIG. 1 shows a top perspective view of an electronic device in accordance with the described embodiments.

FIG. 2A shows a representative shot peening saturation curve in accordance with the described embodiments.

FIG. 2B shows a representative shot peening curve in accordance with the described embodiment.

FIG. 3 shows a flowchart detailing process in accordance with the described embodiments.

FIG. 4 shows a flowchart detailing process for determining saturation curve for a shot peening process in accordance with the described embodiments.

FIG. 5 shows a flowchart detailing process for determining a nozzle pressure dependent variation of arc height in accordance with the described embodiments.

FIG. 6 shows a flowchart detailing process for determining the single machine variation operation in accordance with the described embodiments.

FIG. 7 shows a flowchart detailing process for determining the machine to machine variation operation in accordance with the described embodiments.

FIG. 8 shows a flowchart detailing process for determining the component to test strip correlation operation in accordance with the described embodiments.

FIG. 9 is a block diagram of an electronic device suitable for use with the described embodiments.

### DETAILED DESCRIPTION OF SELECTED EMBODIMENTS

Reference will now be made in detail to representative embodiments illustrated in the accompanying drawings. It should be understood that the following descriptions are not intended to limit the embodiments to one preferred embodiment. To the contrary, it is intended to cover alternatives, modifications, and equivalents as can be included within the spirit and scope of the described embodiments as defined by the appended claims.

Shot peening has been common practice in the treatment of metal components to increase surface hardness, fatigue life as well as provide a desired cosmetic finish to consumer electronic products. Regarding the latter, many of today's consumer lever computing products such as laptops provide a powerful computing platform in an aesthetically pleasing form. For example, a portable computing platform, such as the MacBook Pro™ manufactured by Apple Inc. of Cupertino, Calif. provides an end-user with a powerful computer enclosed in a thin aluminum housing. In the context of this discussion, the term thin can refer to the relative lateral dimension of the housing compared to a nominal thickness of the housing. For example, representative laptop housing can be formed of aluminum having a length L of about 13 inches (330 mm) and a thickness t on the order of 0.6-0.8 mm.

In order to provide the necessary finish to the top surface of the aluminum housing, the top surface is exposed to shot peening process using iron peening media creating a textured surface formed of indentations having an average size of about 50 microns. The kinetic energy deposited by the iron media during the shot peening process not only toughens the surface of the aluminum housing (helping to prevent crack migration), but also induces a compressive force. The compressive force can be balanced somewhat by another shot peening process carried out on the bottom surface of the aluminum housing. However, due to the difference in surface areas between the top and bottom surfaces of the aluminum housing, a net bowing force can be developed between the two surfaces that can cause the aluminum housing to undergo a physical distortion in the form of an arc. For example, an aluminum housing having length L of about 330 mm, an average bow (or arc) height ranging from about 0.4 to about 0.8 mm can be expected which can cause fit and finish problems during assembly. For example, when installing a display assembly into the housing, any bowing of the housing can cause problems with properly fitting the display within the enclosure formed by the housing.

Hence, it is critically important for a proper fit and finish for the effect of shot peening on the geometric integrity be both well understood and controlled. This is particularly true of situations where a large number of thin walled consumer products are mass produced using a shot peening process carried out at various locations and under varying conditions. For example, typical shot peening operations require that the peening media be replenished at specific intervals (either absolute time or peening time being that time that the media is actually used). However, different shot peening vendors can replenish the media at different times and duration of use rendering any meaningful correlation between the shot peening processes unreliable having the effect of increasing the variability of the properties of the finished product.

Therefore, in order to provide a more reliable and controlled shot peening process in a mass production environment, the shot peening process must be well characterized. In order to well characterize the shot peening process, a number of shot peening process parameters must be considered. Two shot peening process parameters of particular importance are peening intensity and peening coverage. Peening intensity is a function of the kinetic energy of the peening media (or shot) impacted upon the surface of the component that, in turn, is a function of shot velocity and shot size. Commonly, shot is accelerated by using air pressure to force the shot through a peening nozzle which is directed at the surface undergoing peening.

Intensity refers to the kinetic energy with which the peening media strikes the part. This energy controls the depth of the peening effect. It is measured by shot peening a flat, hardened steel strip called an Almen strip, in the same manner as the part will be peened. The strip is held flat on an Almen block placed in the representative location during the peening operation. When released from the block, the strip will bow convexly on the peened surface. The amount of bow is measured using a gauge and is called the arc height. In order to measure the peening intensity, it has been found that the most effective method for production measurements of shot peening effect is the use of steel Almen strips. However, it has been discovered that the use of steel Almen strips does not provide the requisite resolution required to characterize the effect of shot peening using iron media on thin aluminum workpieces, such as laptop housing. Therefore, aluminum Almen strips are used that provide the requisite resolution. For example, a representative aluminum Almen strip formed of Al5050 aluminum having a nominal thickness of about 0.7 to about 0.8 provides an acceptable response.

In order to characterize the effect of the shot peening process on the thin walled aluminum workpieces, the aluminum Almen test strip is mounted to a standardized test specimen in a customary mounting block. One side of the Almen strip is shot peened causing the strip to deform and bow due to the resulting compressive stress layer at the surface. The specimen is then removed and the curve induced by shot peening is measured using an appropriate Almen gauge. The appropriate Almen gauge is one having a resolution suitable for determining arc, or bow, heights on the order of 0.4 to 0.8 mm having a resolution of about 0.0001 mm. Whenever a processing procedure is developed for a new part, an intensity curve must be developed which establishes the time required to reach peening saturation of the Almen strip. This is accomplished by shot peening several strips at various times of exposure to the shot stream and plotting the resulting arc heights. Saturation is defined as that point at which doubling the time of exposure will result in no more than a 10 percent increase in arc height.

The measured deflection is proportional to the Almen intensity, or the intensity of the shot peening process. Almen strip verification is widely used however the accuracy of the measurement can be affected by factors such as the Almen strip hardness, flatness and the production lot. Therefore the Almen intensity is not solely a function of shot peening parameters such as the shot velocity exposure time, and flow rate. Because it is difficult to directly measure the effects of shot peening on a part, a high degree of process control is essential to assure repeatability.

Shot size and shape must be carefully controlled during the shot peening process, to minimize the number of fragmented particles caused by fracturing of the shot. These fragmented particles can cause surface damage. Also, as a result of lower mass, fragmented shot particles will lengthen the time to reach a specified peening intensity. Periodic inspection and replenishment of the shot is required to control shot size and shape within specification limits.

Therefore, one aspect of the described embodiments relates to providing correlation between arc height evidenced by an Almen strip and the actual arc height exhibited by a thin walled component. In the following discussion, a “thin wall” is a wall defining two main opposite faces, with the square root of the area of each face being definitely greater than the mean distance between said two faces, e.g. greater by a factor of at least five, preferably by a factor of more than ten, and preferably by a factor of at least thirty.

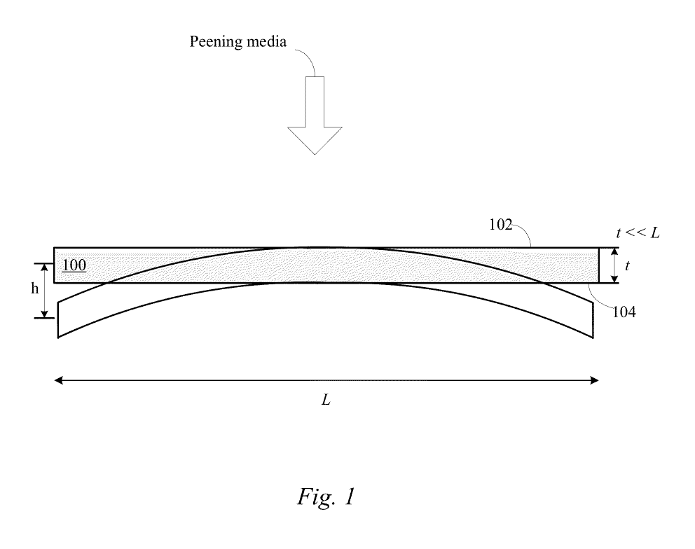

These and other embodiments are discussed below with reference to FIGS. 1-8. However, those skilled in the art will readily appreciate that the detailed description given herein with respect to these figures is for explanatory purposes only and should not be construed as limiting.

FIG. 1 shows representative cross section of housing 100 having been exposed to a shot peening process in accordance with the described embodiment. Housing 100 can be formed of metal, such as aluminum. The dimensions of housing 100 can be such that the ratio of lateral dimensions (such as length L) can be substantially greater than nominal thickness t. Using housing 100 as an example, housing 100 can be formed of aluminum having length L of about 330 mm and thickness t of about 0.5 mm. In this way, housing 100 can be characterized as being thin with regards to the ratio of the lateral dimensions and thickness. Therefore, any residual compressive force created in top surface 102 during a shot peening process that is not fully balanced by a second peening process on bottom surface 104 can cause bowing of housing 100. For example, it can be expected that aluminum housing 100 can experience a concave bowing due to a shot peening process that can result in aluminum housing 100 experiencing a concave bowing having arc height h of about 0.5 to about 0.8 mm. This concave bowing can adversely affect fitting operational components within or attached to housing 100. For example, if housing 100 is a top case for a laptop computer, the placement of a display assembly within housing 100 can be compromised due to the bowing of the housing especially in those situations where the display assembly is mounted directly to housing 100. Moreover, the bowing of the housing 100 when used as the top case in a laptop computer can result in the display assembly itself bowing commensurate with the bowing of aluminum housing 100 which, in some cases, can result in a protective layer of the display assembly impinging on a bottom case when the laptop computer is closed. This repeated impinging of the protective layer on the bottom case can eventually cause visible wear marks on the protective layer.

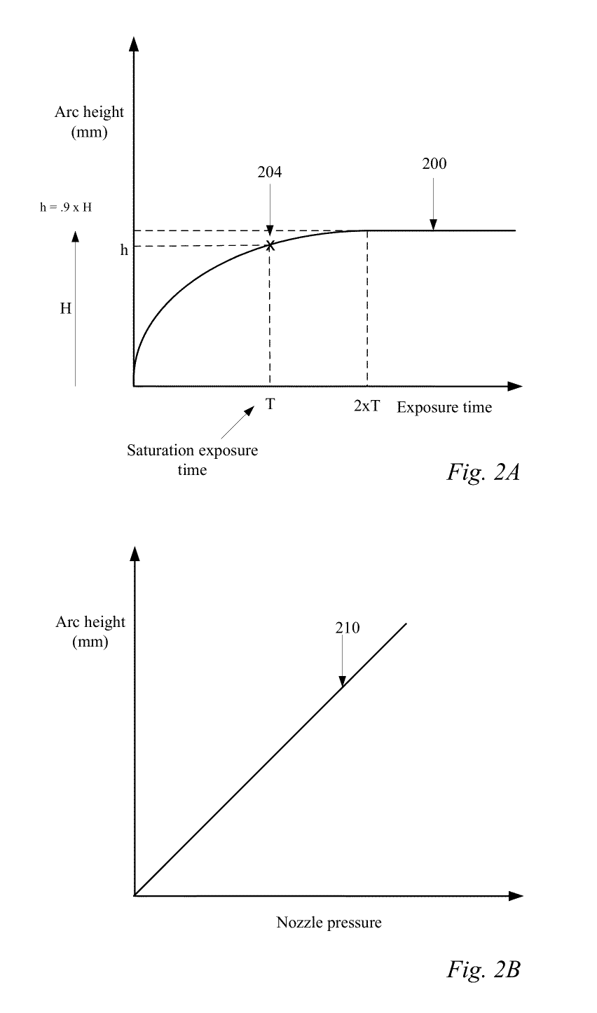

FIG. 2A shows a representative shot peening saturation curve 200 in accordance with the described embodiments. Shot peening saturation curve 200 is a graphical representation of the plotted points of arc height h over exposure time T that determines the shot peening intensity at saturation. It should be noted that shot peening saturation curve 200 is derived based upon a constant shot peening pressure P. As can be seen, the shot peening effect (measured as arc height h developed in a number of aluminum Almen strips) saturates at saturation point 204 represented as the earliest point in curve 200 where arc height h increases by 10% or less when exposure time T is doubled.

FIG. 2B shows a representative shot peening curve 210 in accordance with the described embodiment. In particular, shot peening curve 210 shows the relationship between arc height h and nozzle pressure P. As can be seen, there is no saturation point as nozzle pressure P is increased as opposed to saturation point 204 of saturation curve 200.

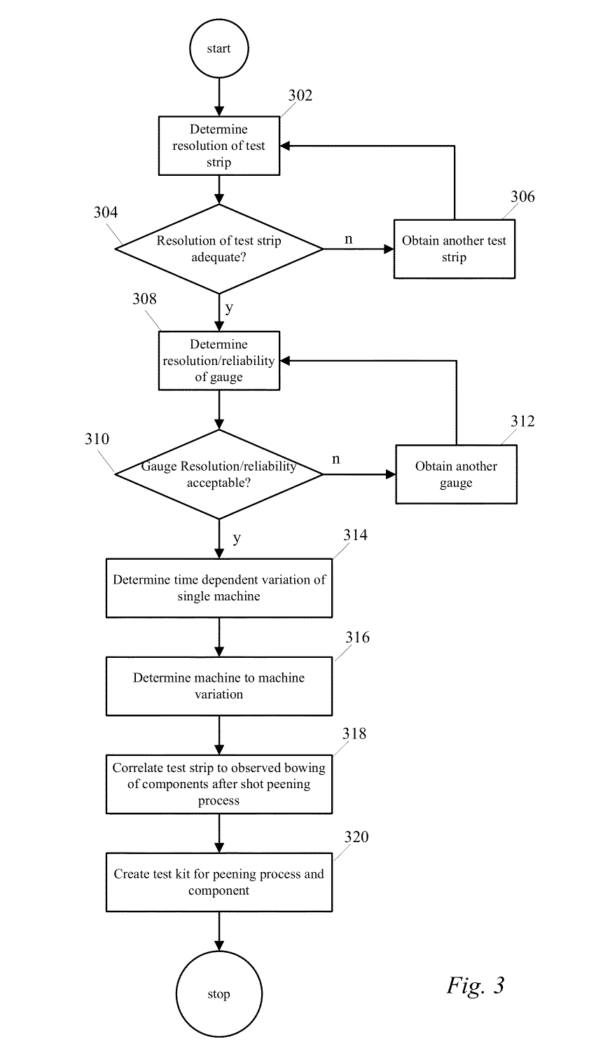

FIG. 3 shows a flowchart detailing process 300 in accordance with the described embodiments. Process 300 can be used to provide a reliable and repeatable shot peening manufacturing process carried out over a number of independent shot peening vendors. Process 300 can start at 302 by determining a resolution of an Almen test strip. In the described embodiment, the Almen test strip is formed of AL5050 aluminum having a similar response to the shot peening process as that of representative aluminum components in mass production. At 304, if the resolution of the Almen test strip is not acceptable, then another test strip is obtained at 306 and process 302-304 is repeated until the test strip resolution is acceptable. When the test strip resolution is acceptable, then at 308, a resolution/reliability of an Almen test gauge is determined By resolution it is meant that the ability of the Almen test gauge to accurately measure a bow height in an aluminum Almen test strip. In one embodiment, the resolution of the Almen test gauge can be on the order of about 0.0001 mm. By reliability it is meant the ability of the Almen test gauge to provide consistent measurement results from one measurement of the Almen test strip to another.

If at 310, either the reliability or resolution of the Almen test gauge is not acceptable, then another Almen test gauge is obtained at 312 and 308-310 are repeated until an acceptable Almen test gauge is obtained. Once an acceptable Almen test gauge is obtained, a time dependent variation of a single shot peening machine (hereinafter referred to as a blaster) is determined at 314. The time dependent variation can be determined by, for example, running a single, or multiple, Almen test strips on a single blaster for specific periods of time and measuring the resulting Almen test strip arc heights. Once the time dependent variation of a single machine is determined, then at 316 a machine to machine variation is determined The machine to machine variation can account for variation in shot peening process parameters in a mass production environment. At 318, once the machine to machine variation is determined, then a correlation is performed between a single or a number of Almen test strips and a corresponding component. The correlation can be used to accurately set specific shot peening process parameters based upon actual results. At 320, selected portions of the data provided by process 300 is provided in a shot peening process test kit that can be used by outside vendors to characterize and set parameters for their particular shot peening process.

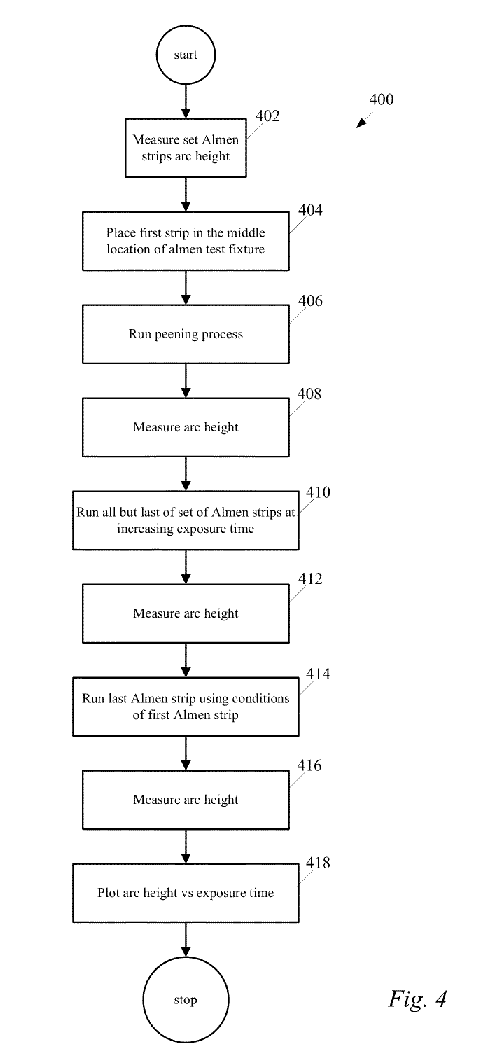

FIG. 4 shows a flowchart detailing process 400 for determining saturation curve for a shot peening process in accordance with the described embodiments. Process 400 begins at 402 by measuring a set of Almen test strips to determine an initial condition. At 404, a first one of the set of Almen test strips is placed in a central portion of an Almen test fixture. At 406, a first shot peening process is run exposing the first Almen test strip to peening media at a fixed nozzle pressure P. At 408, the arc height of the first Almen test strip is measured at the conclusion of the first peening process. At 410, the entire remaining Almen test strips save for a last Almen test strip is exposed to corresponding shot peening process each having an increased exposure time with respect to a previous Almen test strip. At 412, the arc heights of each of the Almen test strips from 410 are measured while at 414, the last remaining Almen test strip is exposed to the shot peening process at the conditions (i.e., exposure time and pressure) as the first test strip and measured at 416. At 418, a plot of arc height to exposure time is provided (see FIG. 2A as an example).

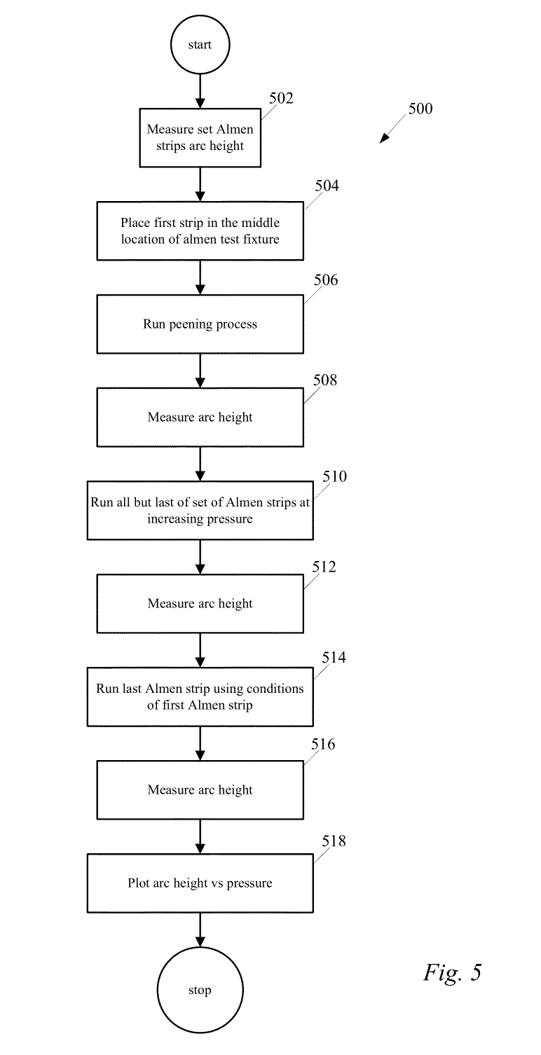

FIG. 5 shows a flowchart detailing process 500 for determining a nozzle pressure dependent variation of arc height in accordance with the described embodiments. Process 500 begins at 502 by measuring a set of Almen test strips to determine an initial condition. At 504, a first one of the set of Almen test strips is placed in a central portion of an Almen test fixture. At 506, a first shot peening process is run exposing the first Almen test strip to peening media at a fixed nozzle pressure P. At 508, the arc height of the first Almen test strip is measured at the conclusion of the first peening process at the first nozzle pressure value. At 510, all of the remaining Almen test strips save for a last Almen test strip is exposed to corresponding shot peening process each having an increased nozzle pressure with respect to a previous Almen test strip. At 512, the arc heights of each of the Almen test strips from 510 are measured while at 514, the last remaining Almen test strip is exposed to the shot peening process at the conditions (i.e., exposure time and pressure) as the first test strip and measured at 516. At 518, a plot of arc height to nozzle pressure is provided (see FIG. 2B as an example).

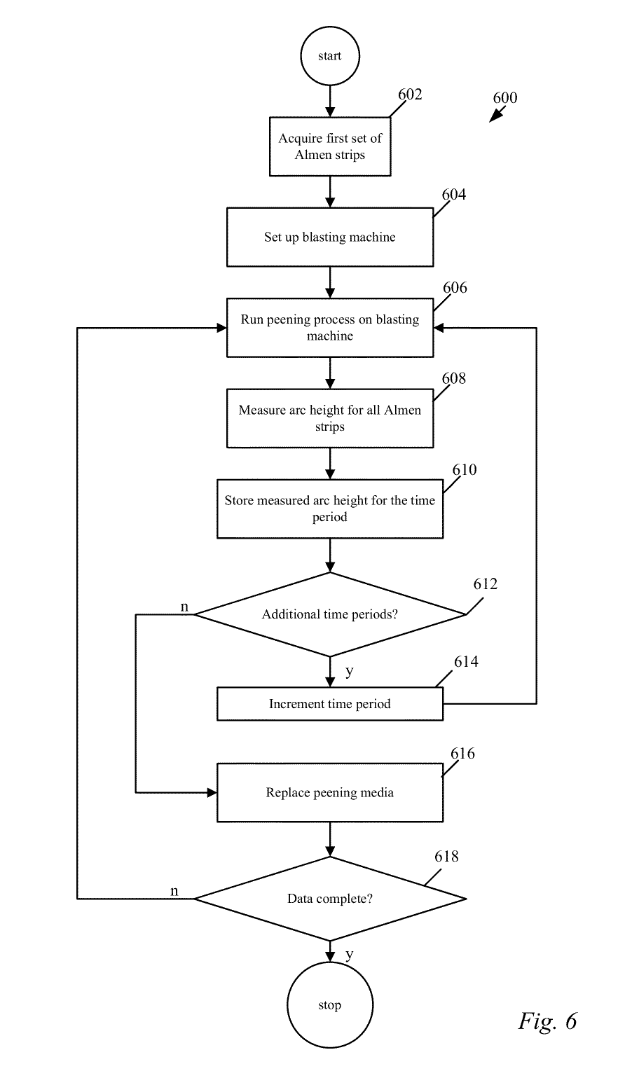

FIG. 6 shows a flowchart detailing process 600 for determining the single machine variation operation 314 in accordance with the described embodiments. Process 600 begins at 602 by measuring a set of Almen test strips to determine an initial condition. At 604, a blasting machine being evaluated is set up. At 606, a shot peening process is run for a first exposure time exposing the Almen test strips to peening media at a fixed nozzle pressure P. At 608, the arc height of the Almen test strips is measured at the conclusion of the peening process. At 610, the arc heights for the first exposure time are stored. At 612, a determination is made if there is additional exposure time periods. If there are additional exposure time periods, then the exposure time is incremented at 614, and control is passed back to 606, otherwise the peening media is replaced at 616 and process 600 is repeated using the new peening media or until a complete data set is obtained as determined at 618.

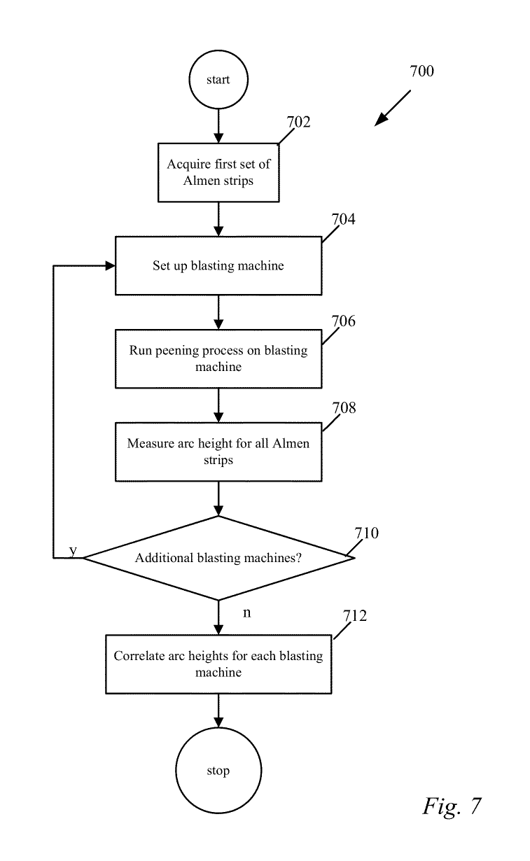

FIG. 7 shows a flowchart detailing process 700 for determining the machine to machine variation operation 316 in accordance with the described embodiments. Process 700 begins at 702 by measuring a set of Almen test strips to determine an initial condition. At 704, a blasting machine being evaluated is set up. At 706, a shot peening process is run for a first exposure time exposing the Almen test strips to peening media at a fixed nozzle pressure P. At 708, the arc height of the Almen test strips is measured at the conclusion of the peening process. At 710, if there are additional blasting machines to be evaluated, then control is passed to 704, otherwise the arc heights for the evaluated blasting machines are correlated at 712.

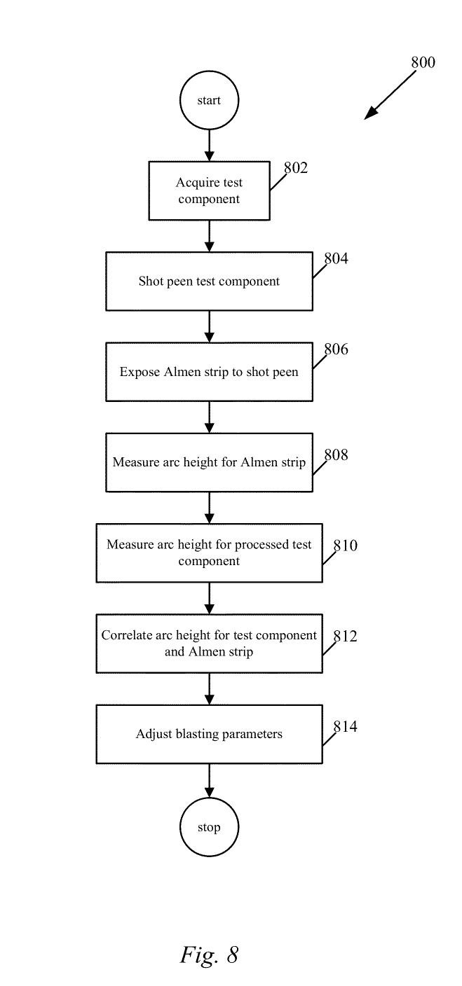

FIG. 8 shows a flowchart detailing process 800 for determining the component to test strip correlation operation 318 in accordance with the described embodiments. Process 800 begins at 702 by acquiring a test component. The test component is then exposed to the shot peen process at 704 and a correlating Almen test strip is exposed to the shot peen process at 706. The arc height of the Almen strip is measured at 708, and at 808, the arc height of the component under test is determined at 810. The arc height of the Almen strip and the component under test is correlated at 812 and at 814 the shot peening process parameters are calibrated based upon the correlation between the Almen test strip and the component under test.

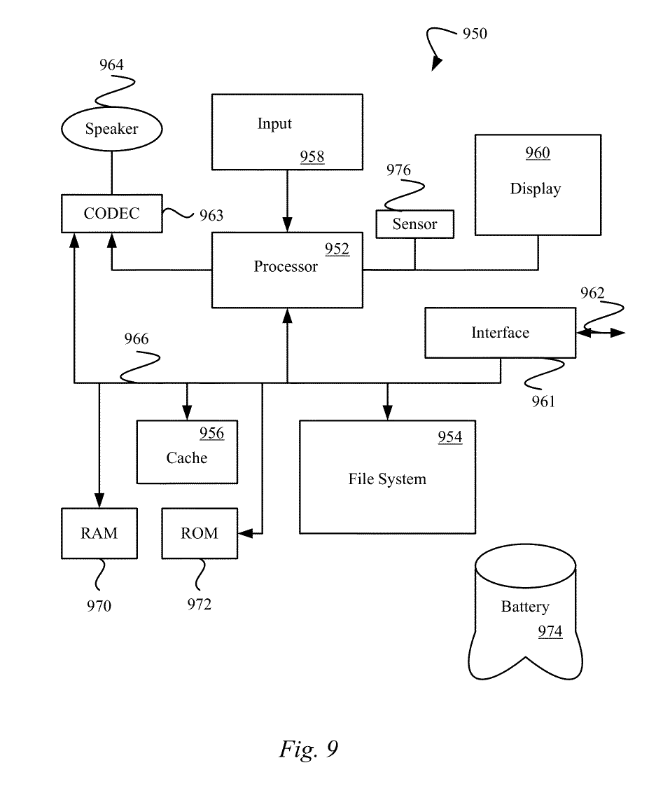

FIG. 9 is a block diagram of an electronic device 950 suitable for use with the described embodiments. The electronic device 950 illustrates circuitry of a representative computing device. The electronic device 950 includes a processor 952 that pertains to a microprocessor or controller for controlling the overall operation of the electronic device 950. The electronic device 950 stores media data pertaining to media items in a file system 954 and a cache 956. The file system 954 is, typically, a storage disk or a plurality of disks. The file system 954 typically provides high capacity storage capability for the electronic device 950. However, since the access time to the file system 954 is relatively slow, the electronic device 950 can also include a cache 956. The cache 956 is, for example, Random-Access Memory (RAM) provided by semiconductor memory. The relative access time to the cache 956 is substantially shorter than for the file system 954. However, the cache 956 does not have the large storage capacity of the file system 954. Further, the file system 954, when active, consumes more power than does the cache 956. The power consumption is often a concern when the electronic device 950 is a portable media device that is powered by a battery 974. The electronic device 950 can also include a RAM 970 and a Read-Only Memory (ROM) 972. The ROM 972 can store programs, utilities or processes to be executed in a non-volatile manner The RAM 970 provides volatile data storage, such as for the cache 956.

The electronic device 950 also includes a user input device 958 that allows a user of the electronic device 950 to interact with the electronic device 950. For example, the user input device 958 can take a variety of forms, such as a button, keypad, dial, touch screen, audio input interface, visual/image capture input interface, input in the form of sensor data, etc. Still further, the electronic device 950 includes a display 960 (screen display) that can be controlled by the processor 952 to display information to the user. A data bus 966 can facilitate data transfer between at least the file system 954, the cache 956, the processor 952, and the CODEC 963.

In one embodiment, the electronic device 950 serves to store a plurality of media items (e.g., songs, podcasts, etc.) in the file system 954. When a user desires to have the electronic device play a particular media item, a list of available media items is displayed on the display 960. Then, using the user input device 958, a user can select one of the available media items. The processor 952, upon receiving a selection of a particular media item, supplies the media data (e.g., audio file) for the particular media item to a coder/decoder (CODEC) 963. The CODEC 963 then produces analog output signals for a speaker 964. The speaker 964 can be a speaker internal to the electronic device 950 or external to the electronic device 950. For example, headphones or earphones that connect to the electronic device 950 would be considered an external speaker.

The electronic device 950 also includes a network/bus interface 961 that couples to a data link 962. The data link 962 allows the electronic device 950 to couple to a host computer or to accessory devices. The data link 962 can be provided over a wired connection or a wireless connection. In the case of a wireless connection, the network/bus interface 961 can include a wireless transceiver. The media items (media assets) can pertain to one or more different types of media content. In one embodiment, the media items are audio tracks (e.g., songs, audio books, and podcasts). In another embodiment, the media items are images (e.g., photos). However, in other embodiments, the media items can be any combination of audio, graphical or visual content. Sensor 976 can take the form of circuitry for detecting any number of stimuli. For example, sensor 976 can include a Hall Effect sensor responsive to external magnetic field, an audio sensor, a light sensor such as a photometer, and so on.

The various aspects, embodiments, implementations or features of the described embodiments can be used separately or in any combination. Various aspects of the described embodiments can be implemented by software, hardware or a combination of hardware and software. The described embodiments can also be embodied as computer readable code on a non-transitory computer readable medium. The computer readable medium is defined as any data storage device that can store data which can thereafter be read by a computer system. Examples of the computer readable medium include read-only memory, random-access memory, CD-ROMs, DVDs, magnetic tape, and optical data storage devices. The computer readable medium can also be distributed over network-coupled computer systems so that the computer readable code is stored and executed in a distributed fashion.

The foregoing description, for purposes of explanation, used specific nomenclature to provide a thorough understanding of the described embodiments. However, it will be apparent to one skilled in the art that the specific details are not required in order to practice the described embodiments. Thus, the foregoing descriptions of the specific embodiments described herein are presented for purposes of illustration and description. They are not target to be exhaustive or to limit the embodiments to the precise forms disclosed. It will be apparent to one of ordinary skill in the art that many modifications and variations are possible in view of the above teachings.

The advantages of the embodiments described are numerous. Different aspects, embodiments or implementations can yield one or more of the following advantages. Many features and advantages of the present embodiments are apparent from the written description and, thus, it is intended by the appended claims to cover all such features and advantages of the invention. Further, since numerous modifications and changes will readily occur to those skilled in the art, the embodiments should not be limited to the exact construction and operation as illustrated and described. Hence, all suitable modifications and equivalents can be resorted to as falling within the scope of the invention.

What is claimed is:

1. A method for creating a shot peening process test kit, comprising:
(a) determining a time dependent variation of a shot peening machine;
(b) determining a machine to machine variation between a plurality of shot peening machines;
(c) measuring an arc height of a component under test subsequent to a shot peening process;
(d) correlating the measured arc height to a measured arc height of an aluminum Almen test strip exposed to the shot peening process; and
(e) creating a shot peening test kit in accordance with (a)-(d).

2. The method as recited in claim 1, the determining the time dependent variation of the shot peening machine comprising:
setting up the shot peening machine arranged to execute a first shot peening process;
exposing a first Almen test strip to the first shot peening process for a first exposure time;
measuring the arc height of the first Almen strip at the end of the first exposure time; and
incrementing the first exposure time.

3. The method as recited in claim 2, further comprising;
replacing the current shot peening media with new shot peening media; and
repeating the determining the time dependent variation of the shot peening machine using the new shot peening media.

4. The method as recited in claim 2, the correlating the measured height of the component under test to the arc height of the Almen strip, comprising:
placing the Almen strip into the shot peening machine;
exposing the Almen strip to the shot peening media during the shot peening process; and
measuring the Almen strip.

5. The method as recited in claim 4, father comprising
placing the component under test into the shot peening machine;
exposing the component under test to the shot peening media during a subsequent shot peening process; and
measuring the arc height of the component under test.

6. The method as recited in claim 5, father comprising correlating the arc height for the component under test and the Almen test strip.

7. The method as recited in claim 1, the determining the machine to machine variation between a plurality of shot peening machines, comprising:
setting up a first shot peening machine;
exposing an Almen test strip during a shot peening process executed by the first shot peening machine; and
measuring an arc height of the Almen test strip at the conclusion of the shot peening process.

8. The method as recited in claim 7, further comprising:
setting up a second shot peening machine;
exposing a second Almen test strip during a shot peening process executed by the second shot peening machine; and
measuring an arc height of the second Almen test strip at the conclusion of the second shot peening process.

9. The method as recited in claim 8, further comprising;
correlating the first and second arc heights.

10. An apparatus for creating a shot peening process test kit, comprising:
means for determining a time dependent variation of a shot peening machine;
means for determining a machine to machine variation between a plurality of shot peening machines;
means for measuring an arc height of a component under test subsequent to a shot peening process;
means for correlating the measured arc height to a measured arc height of an aluminum Almen test strip exposed to the shot peening process; and
means for creating a shot peening test kit.

11. The apparatus as recited in claim 10, the determining the time dependent variation of the shot peening machine comprising:
means for setting up the shot peening machine arranged to execute a first shot peening process;
means for exposing a first Almen test strip to the first shot peening process for a first exposure time;
means for measuring the arc height of the first Almen strip at the end of the first exposure time; and
means for incrementing the first exposure time.

12. The apparatus as recited in claim 11, further comprising;
means for replacing the current shot peening media with new shot peening media; and
means for repeating the determining the time dependent variation of the shot peening machine using the new shot peening media.

13. The method as recited in claim 12, the correlating the measured height of the component under test to the arc height of the Almen strip, comprising:
means for placing the Almen strip into the shot peening machine;
means for exposing the Almen strip to the shot peening media during the shot peening process; and
means for measuring the Almen strip.

14. The method as recited in claim 13, father comprising
means for placing the component under test into the shot peening machine;
means for exposing the component under test to the shot peening media during a subsequent shot peening process; and
means for measuring the arc height of the component under test.

15. The apparatus as recited in claim 14, father comprising means for correlating the arc height for the component under test and the Almen test strip.

16. The apparatus as recited in claim 10, the means for determining the machine to machine variation between a plurality of shot peening machines, comprising:
means for setting up a first shot peening machine;
exposing an Almen test strip during a shot peening process executed by the first shot peening machine; and
means for measuring an arc height of the Almen test strip at the conclusion of the shot peening process.

17. The apparatus as recited in claim 16, further comprising:
means for setting up a second shot peening machine;
means for exposing a second Almen test strip during a shot peening process executed by the second shot peening machine; and
means for measuring an arc height of the second Almen test strip at the conclusion of the second shot peening process.

18. The apparatus as recited in claim 17, further comprising;
means for correlating the first and second arc heights.
